(19) United States
(12) Patent Application Publication
(10) Pub. No.: US 2007/0040768 A1
(43) Pub. Date: Feb. 22, 2007

(54) Display apparatus

(76) Inventor: Toshimitsu Watanabe, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/498,131

(22) Filed: Aug. 3, 2006

(30) Foreign Application Priority Data
Aug. 5, 2005 (JP) 2005-227372

(51) Int. Cl. G09G 3/20

(52) U.S. Cl. 345/75.2

(57) ABSTRACT

The present invention provides a technique for reducing power losses in a display apparatus such as an FED, especially power losses due to leak currents occurring when a non-selective voltage is applied. A display apparatus according to the invention is provided with scan drivers for selecting one line at a time, for instance, out of a plurality of electron sources placed in a matrix form. The scan drivers supply a selective voltage from a first voltage source to a selective line and a non-selective voltage from a second voltage source to non-selective lines. A resistor is connected to the second voltage source. Since leak currents flowing to non-selective lines are reduced by the resistor in the non-selective period, power losses due to leak currents can be reduced.

### CLAIM OF PRIORITY

The present application claims priority from Japanese Application JP 2005-227372 filed on Aug. 5, 2005, the content of which is hereby incorporated by reference into this application.

### BACKGROUND OF The INVENTION

1. Field of the Invention

The present invention relates to a display apparatus which forms an image of electrons emitted from a plurality of electron sources placed in a matrix form.

2. Description of the Related Art

A display apparatus which forms an image by using electrons emitted from a plurality of electron sources placed in a matrix form is known as, for instance, an FED or an SED (hereinafter they may be sometimes collectively referred to as “FED”). Pulse-shaped driving voltages and selective voltages or non-selective voltages based on image signals are applied to the electron sources. The selective voltage is intended for selecting, for instance, one line of electron sources, and the successive application of selective voltages in the row direction of electron sources (vertical direction) results in sequential scanning. Non-selective voltages are applied to electron sources on all other lines. The one line of electron sources to which the selective voltages emits electrons of a quantity matching the pulse height or the pulse width of the driving voltage. The electron sources to which the non-selective voltages have been applied are prevented from emitting electrons irrespective of the level of driving voltages. Such an FED configuration is disclosed in, for instance, the Japanese Patent Laid-Open No. H9-297556.

### SUMMARY OF THE INVENTION

In an FED of the above-described configuration, during the period in which non-selective voltages are applied, namely the non-selective period, electron sources do not emit electrons and therefore it is basically desirable for no power loss accompanying scans to arise.

Incidentally, scanning lines for supplying selective voltages or non-selective voltages to the electron sources placed in a matrix form (hereinafter referred to as “line wires”) and data lines for supplying driving voltages (hereinafter referred to as “row wires”) cross each other via insulators. Therefore, where the scanning lines and the data lines are not fully insulated from each other, micro-currents arise at their intersections even during a non-selective period. Hereinafter, such currents will be referred to as leak currents,

Thus the FED, even during a non-selective period, is subject to the generation of leak currents at the intersections according to the potential difference between the driving voltage and the non-selective voltage, and consequently to the generation of a power loss. For instance, where the horizontal number of pixels (the number of electron sources) is 1280 (or 3840 where the electron sources of the three colors including R, G and B are horizontally arrayed) and the vertical number of pixels is 720, leak currents corresponding to 1280×3×(720−1)=2,760,960 electron sources will flow, with the exception of the selected one line. Supposing that the leak current per electron source is 1 μA, the total of the leak currents will be 2.76 A. Therefore, even during a non-selective period, if the non-selective voltage applied to the line wires is 4 V, there will arise a power loss of 2.76×4=11 W.

The present invention is intended to provide a technique that is suitably applicable to reducing power losses. The invention is characterized in that it achieves this purpose by, when non-selective voltages are to be applied to electron sources, applying the non-selective voltage to the electron sources via a current suppressing element such as a resistor. As the amperages of the leak currents arising when non-selective voltages are applied are lowered, power losses due to the leak currents are reduced.

Here, with the capacitance of the electron sources being represented by C, the resistance of the resistor by R and the number of electron sources in the line direction by N, it is preferable to so set the resistance R of the resistor as to satisfy the condition of Mathematical Expression 1 below. This makes it possible to prevent a time constant determined by the product of the resistance R of the resistor and the capacitance C of the electron sources from increasing substantially and thereby to restrain the drop in the responsiveness of the electron sources.
R·(C·N)≦0.2[μS] (Mathematical Expression 1)

Further, with the leak current flowing to one of the electron sources in the non-selective state due to a potential difference between the driving voltage and the non-selective voltage being represented by Iₗₑₐₖ, the number of electron sources in the line direction by N, the number of electron sources in the row direction by M and the level of the non-selective voltage by V_REF, it is preferable to so control the leak current Iₗₑₐₖ with the resistor as to satisfy the condition of Mathematical Expression 2 below. This makes it possible to restrain the power loss during the non-selective period to 1 W or less.
[Iₗₑₐₖ·N·(M−1)·V_REF≦1[W] (Mathematical Expression 2)

Further, with the resistance R of the resistor being represented by R, the resistance of the line wire by Rs, the level of the voltage driving the row wires by E and the amperage to be restrained by I, the resistance R of the resistor may as well be so set as to satisfy the condition of Mathematical Expression 3 below.
R=E/I−Rs (Mathematical Expression 3)

As described above, the invention makes it possible to reduce power losses, especially power losses due to leak currents which arise when non-selective voltages are applied.

### BRIEF DESCRIPTION OF THE DRAWINGS

FIG. 1 is a block diagram showing an example of a display apparatus to which the present invention is applied.

FIG. 2 shows one specific example of a display panel 1.

FIG. 3 shows one specific example of an electron source.

FIG. 4 shows the operational waveform of a display apparatus embodying the invention.

FIG. 5 shows the operational characteristics of the electron source.

FIG. 6 shows one specific example of a first embodiment of the invention.

FIG. 7 shows one specific example of a second embodiment of the invention.

### DETAILED DESCRIPTION OF THE EMBODIMENTS

Preferred embodiments of the present invention will be described below with reference to the accompanying drawings. The following description of the embodiments will refer to cases in which metal insulator-metal (MIM) type electron sources are used. These embodiments, however, may as well use elements configured or carbon nano-tubes (CNT), Spindt elements or surface-conduction electron-emitters (SCEs) as electron sources. Thus, the invention is applicable to electron sources of any type which may suffer the occurrence of leak currents in the non-selective period.

[Embodiment 1]

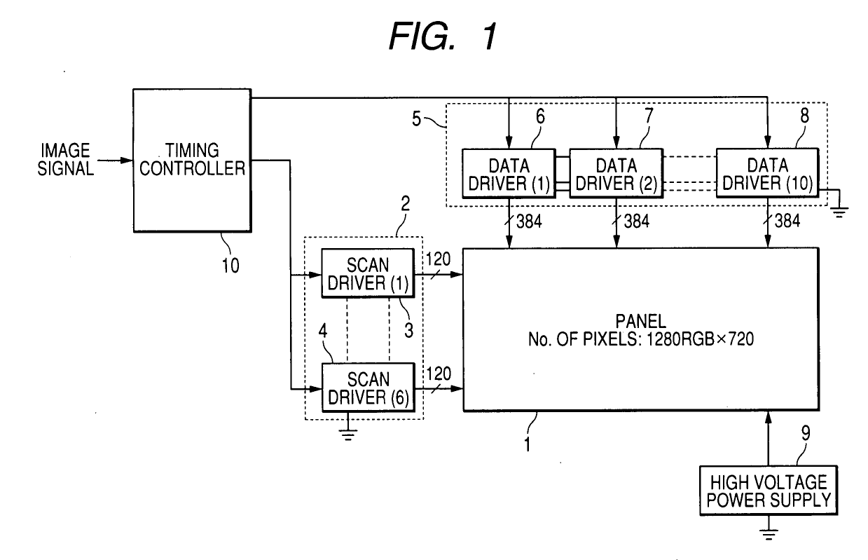

To begin with, a first preferred embodiment of the invention will be described with reference to FIG. 1 through FIG. 6. FIG. 1 is a block diagram showing an outline of a display apparatus which is this embodiment, the apparatus being provided with a display panel 1, which is an FED. The display panel 1 is a passive matrix type panel for forming an image on its display screen, and has row wires, which are data lines, and line wires, which are scanning lines. The row wires extend in the vertical direction of the screen (the shorter side direction of the display screen of the display panel 1; hereinafter it may be sometimes referred to as the “row direction”), and N such wires are placed in the horizontal direction of the screen (the longer side direction of the display screen of the display panel 1; hereinafter it may be sometimes referred to as the “line direction”). On the other hand, the line wires extend in the horizontal direction of the screen, and M such wires are placed in the vertical direction of the screen. MIM type electron sources are connected to the intersections between the row wires and the line wires. Therefore, the total number of electron sources the display panel 1 has is M×N, the number of electron sources per line is N, and that of electron sources per row is M.

Scan drivers 2 are connected to the line wires, and data drivers 5, to the row wires. FIG. 1 shows a case in which the horizontal number of pixels of the display panel 1 (the number of electron sources in the line direction) is 1280×3 and the vertical number of pixels (the number of electron sources in the row direction) is 720. In this case, 10 data drivers 5 are needed if the number of outputs of each is 384, and six scan drivers, if the number of outputs of each is 120. In FIG. 1, the data drivers 5 are represented by circuit blocks 6 through 8 and the scan drivers 2, by circuit blocks 3 and 4. A high voltage power supply circuit 9 is connected to the anode terminal of the display panel 1 to apply a high voltage generated by the high voltage power supply circuit 9. This voltage is, for instance, 10 kV or so.

Image signals, such as television signals or playback signals from a DVD, and their sync signals are supplied to a timing controller 10. The timing controller 10 sends to the scan drivers 2 and the data drivers 5 signals of the best timings for forming an image on the screen of the display panel 1 based on the supplied image signals (signals synchronized with horizontal and vertical sync signals) and image data. In the data drivers 5, image data equivalent to one line on the display panel 1 are held for one horizontal period, and the data are rewritten in every horizontal period. The data drivers 5 generate a driving voltage on the basis of the held one line of image data and apply it to row electrodes.

On the other hand, the scan drivers 2 generate a selective voltage, which is a first scan voltage, and anon-selective voltage, which is a second scan voltage. The selective voltage is generated in response to a horizontal sync signal supplied from the timing controller 10, and so applied to the line wires of the display panel 1 as to successively select (scan) a one line, for instance, of electron sources in the row direction. In this embodiment, the selective voltage is successively applied to M line wires so as to scan one at a time from above at a timing of every horizontal period. When the driving voltage from the data drivers 5 is applied to one line of electron sources to which the selective voltage has been applied (namely the selected electron sources), those electron sources emit a quantity of electrons matching the potential difference between the selective voltage and the driving voltage. The electrons emitted from the electron sources are accelerated by the high voltage of 10 kV applied to the anode terminal of the display panel 1, and collide against phosphors, each placed to match one or another of the electron sources. The phosphors emit light, excited by this collision of electrons.

This causes one horizontal line of an image to be displayed on the screen of the display panel 1. When the scan drivers 2 have successively applied the selective voltage to the line wires of all the lines over one frame period, one frame of image is displayed. In this embodiment, incidentally, the selective voltage and the driving voltage are supposed to be reverse in polarity to each other. For instance, if the selective voltage is positive, the driving voltage is negative.

To the line wires to which the selective voltage is not applied (namely which are in the non-selective period), out of the M line wires, and the electron sources connected thereto, a non-selective voltage is applied. The non-selective voltage is so set that the absolute value of its difference from the maximum level of the driving voltage is smaller than the electron emission start voltage of the electron sources. For instance, where the electron emission start voltage of the electron sources is 6 V and the maximum level of the driving voltage is −4 V, the non-selective voltage is set to 0 V, which is lower than 2 V.

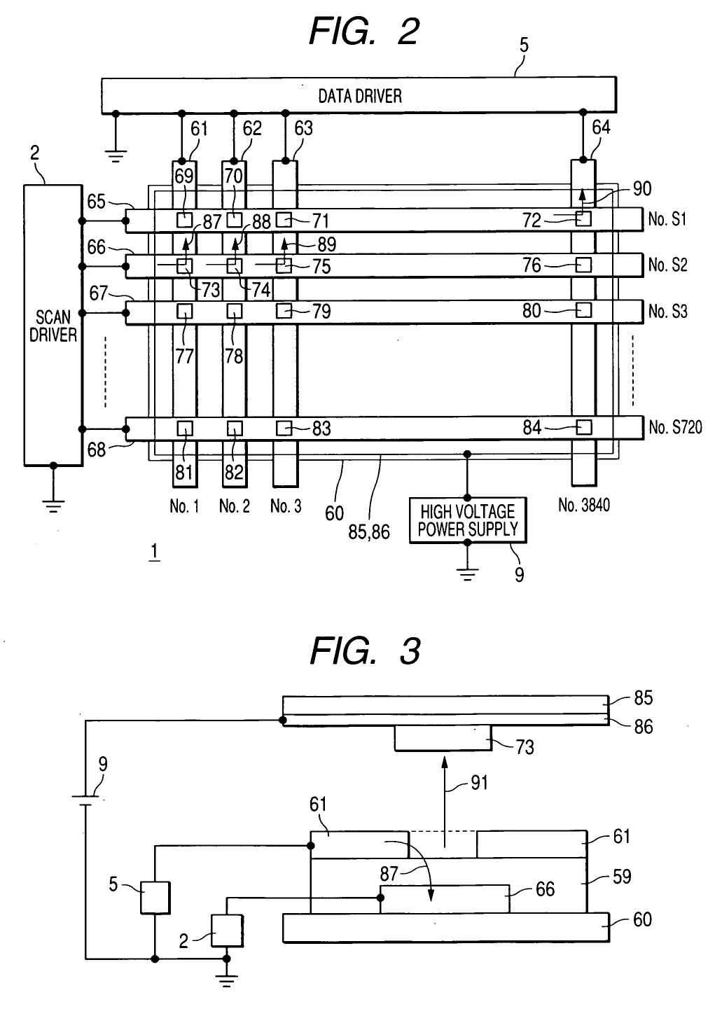

Next, the method of scanning in the display panel 1 and the state of leak current occurrence in the non-selective period will be described with reference to FIG. 2 through FIG. 5. FIG. 2 schematically shows one specific example of inside of the display panel 1. Referring to FIG. 2, line wires 65 through 68 and row wires 61 through 64 are formed over a lower glass substrate 60, and MIM electron sources are disposed at their intersections. When the selective voltage is applied to the line wires and the driving voltage is applied to the row wires, currents 87 through 90 flow to their intersections to drive the electron sources placed at the intersections. On the other hand, over the internal face of an upper glass substrate 85, phosphors 69 through 84 are disposed impositions opposite the electron sources. Further, a high voltage electrode 86 of a transmissive filmy form to which a high voltage from the high voltage power supply circuit 9 is applied is disposed between the phosphors 69 through 84 and the upper glass substrate 85. Incidentally, numerals “No. . . . ” added after the row wires and line wires respectively denote the reference numbers of the row wires and the line wires. The reference numbers of the row wires which are No. 1 through No. 3840 in FIG. 2 indicate that the number N of the row wires is 3840. The reference numbers of the line wires which are No. S1 through No. S720 indicate that the number M of the line wires is 720.

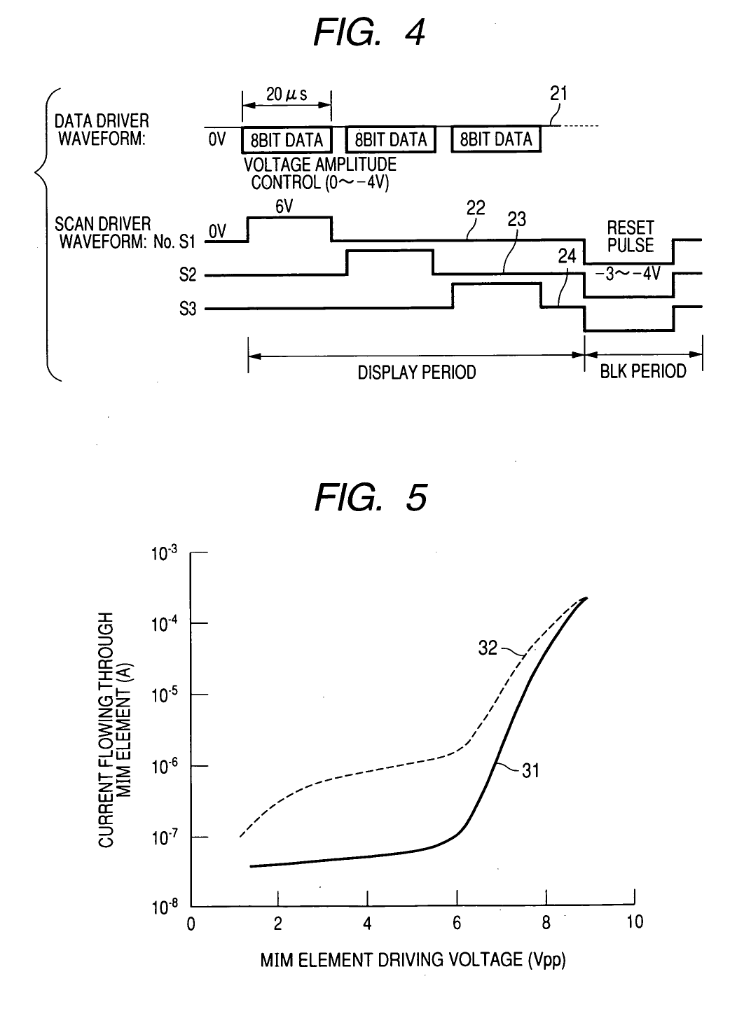

Now let us suppose that a driving voltage having a waveform represented by “Data driver waveform” in FIG. 4 is applied to the row wires 61 through 64 and a selective voltage and a non-selective voltage having a waveform represented by “Scan driver waveform” therein is applied to the line wires 65 through 68. Here, if an image is to be displayed on the second (No. S2) line, a driving voltage matching the brightness information of the image signal (0 to −4 V in FIG. 4) is applied to the line wires 61 through 64, and at the same time a selective voltage represented by a waveform 23 (a pulse signal having a level of 6 V) is applied to the line wire No. S2. While this pulse signal is being applied, the electron source connected to the line wire 66, which is the second line wire, is in a selective state to be capable of emitting electrons according to the driving voltage. In other periods than the selective period during which the selective voltage is applied, the non-selective voltage, which is 0 V, is applied. Further, during the vertical blanking period (BLK period) of the image signal, a reset pulse having a voltage of −3 to −4 V is applied from the scan drivers 2 to the line wires. This reset pulse is intended for taking out the electrons accumulated in the electron sources to elongate the lives of the electron sources, and is reverse in polarity to the selective voltage in this embodiment. However, if it is lower than the non-selective voltage, it may have the same polarity as the selective voltage. Thus, the three voltages applied to the line wires are the selective voltage, the non-selective voltage and the reset pulse in the descending order of the level.

The situation of the electron sources placed in the selective state will be described with reference to FIG. 3, where the electron source positioned at the intersection between the second line wire 66 and the first row wire 61 is shown as an example. FIG. 3 shows a typical state of an MIM electron source an example of electron source in a selective state. When a voltage of 6 V to 10 V, which is the potential difference between the selective voltage and the driving voltage is applied between the line wire 66 which is the second line wire and the row wire 61, a current indicated by an arrow 87 flows to the electron source transmitted by an insulator 59. The flowing of this current 87 through the insulator 59 causes electrons to be generated on the surface of the insulator 59. On the other hand, as a high voltage is applied from the high voltage power supply circuit 9 to a high voltage electrode 86 formed over the inner face of the upper glass substrate 85, an electric field in the direction from the lower glass substrate 60 toward the upper glass substrate 85 is generated between the upper glass substrate 85 and the lower glass substrate 60. As a result, electrons over the surface of the insulator 59 are accelerated by the electric field toward a phosphor 73to form an electron beam 91. Excitation of the phosphor 73 by this electron beam 91 causes the phosphor 73 to emit light. The light from the phosphor is emitted outside through the high voltage electrode 86 and the upper glass substrate 85.

The light intensity of the phosphor 73 is proportional to the current density of the electron beam 91. The current density is proportional to a current 87. Thus, when emitting light at high brightness, the current 87 is large, and the current 87 is small when emitting light at low brightness. That is to say, desired gradation can be obtained by appropriately controlling the current density of the electron beam. This characteristic of electron sources will be described with reference to FIG. 5.

FIG. 5 shows an example of voltage-current characteristics of the MIM electron source used in this embodiment. The horizontal axis of FIG. 5 represents the voltage applied between the line wire 66 and the row wire 61, namely the potential difference between the selective voltage and the driving voltage, which will be referred to in this context as the “MIM element driving voltage” or the “MIM voltage”. The vertical axis of FIG. 5 represents the current 87 flowing in the electron sources. A characteristic 31 in FIG. 5 is one example of voltage-amperage characteristic of normally produced electron sources; in a MIM voltage range of up to near 6 V, the amperage is no more than a few tens of pA and constant. Where the MIM element driving voltage is from 6 V to near 10 V, the amperage varies significantly. Since the variation of the current in this voltage range is substantially linear, the desired gradation is obtained within this voltage range. Thus in the MIM voltage range of 6 to 10 V, electrons are emitted from the electron sources, but not at or below 6 V. In this state of non-emission of electron sources, the current flowing in the electron sources (a current of 10 pA in the characteristic 31) will be hereinafter referred to as the leak current.

On the other hand, a voltage-amperage characteristic 32 of the electron source may be considered in which the leak current has increased on account of some problem in production. In this case, the leak current is approximately 1 μA in the MIM voltage is from 0 to near 6 V. This means that, even in some other period than when the line wire No. S2 is selected in FIG. 4, namely in the non-selective period in which a non-selective voltage is applied to the pertinent line wire, application of a driving voltage of 0 to −4 V approximately could cause a relatively large leak current to flow. In a line sequential scan, the selective period during one frame is one line, and all other lines are in the non-selective period. Since the total number of line wires is 720 and the number of electron sources per line is 1280 each for the colors R, G and B in this embodiment, the total sum of leak currents flowing during the non-selective periods in one frame period is 1 μA×128×3×(720−1)=2.76 A.

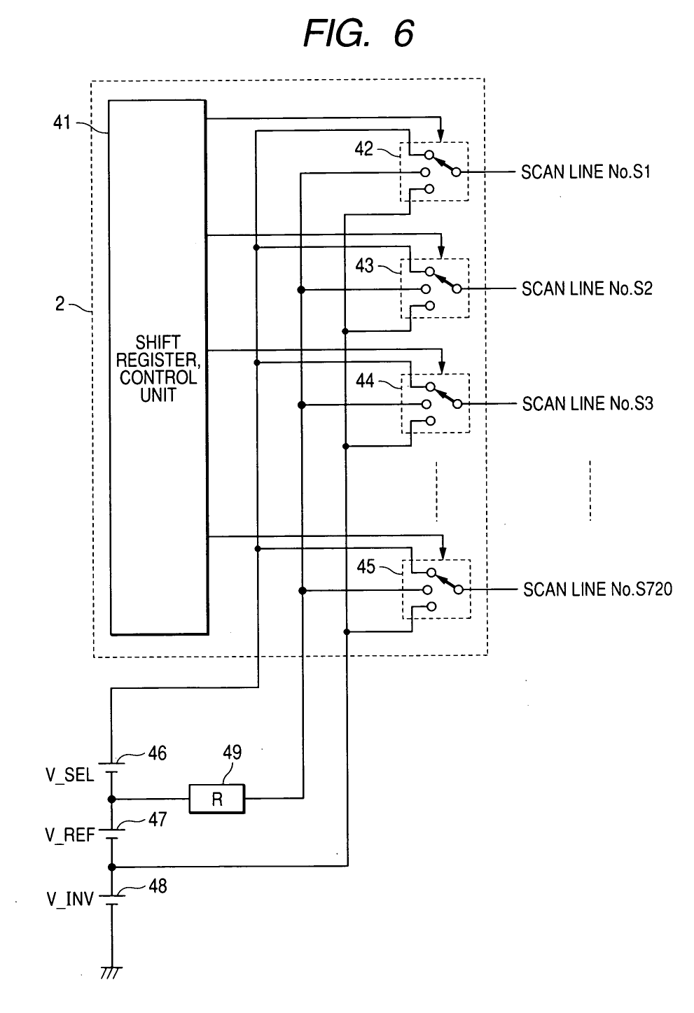

This current flows into the output end of the scan drivers 2 via the line wire 66 as shown in FIG. 3, causes a heavy power loss to occur in the power supply unit of the scan drivers 2. This embodiment is intended to reduce the power loss resulting from such a leak current, and a specific example thereof is shown in FIG. 6.

FIG. 6 shows the circuit configuration of a scan driver 2 for use in the display apparatus of this embodiment and its peripherals. The scan driver 2 comprises a control logic unit 41 which generates control pulses for line sequential scanning and switching elements 42 through 45, each matching one or another of the line wires. Each of the switching elements 42 through 45 has three input terminals, respectively connected to a first voltage source 46, a resistor 49 connected in series to a second voltage source 47, and a third voltage source 48. The switching elements 42 through 45 so operate, each responding to a control pulse from the control logic unit 41, as to select one out of a selective voltage V_SEL from the first voltage source 46, a non-selective voltage V_REF from the second voltage source 47 and a reset voltage V_INV from the third voltage source 48 and supply it to the matching line wire. Although the first, second and third voltage sources are connected in series to each other in this embodiment as shown in FIG. 6, they may as well be connected in parallel.

The control logic unit 41 controls the switching elements 42 through 45 in accordance with horizontal sync and vertical sync signals from the timing controller 10. The control logic unit 41 so controls the switching element 42 as to select the selective voltage V_SEL from the first voltage source 46 when the line wire (scan line) No. S1 is to be selected for instance, and so controls the switching elements 43 through 45 as to select the non-selective voltage V_REF from the second voltage source 47 in all other cases. When the line wire (scan line) No. S2 is to be selected, it so controls the switching element 43 as to select the selective voltage V_SEL from the first voltage source 46, and so controls the switching elements 42, 44 and 45 as to select the non-selective voltage V_REF from the second voltage source 47 in all other cases. Thus, the switching elements 42 through 45 perform an action to switch to the selective voltage V_SEL or the non-selective voltage V_REF in every horizontal period. In the vertical blanking period of an image signal, it so controls the switching elements 42 through 45 as to select the reset voltage V_INV from the third voltage source 48.

As described above, even when the non-selective voltage V_REF is selected, a relatively large leak current may flow. In this embodiment, to reduce that leak current, the resistor 49 is provided as a current restraining element. One end of this resistor 49 is connected to the second voltage source 47, and the other end is connected to one of the input terminals of the switching elements 42 through 45. During the non-selective period, non-selective line wires and electron sources are connected to the resistor 49 by the switching elements 42 through 45. This causes the non-selective voltage V_REF generated by the second voltage source 47 to be applied to the switching elements and line wires via the resistor 49. As a flow of a leak current into this resistor 49 invites a voltage drop, the MIM voltage varies downward (in the left direction of the characteristic 32 in FIG. 5). As a result, the leak current during the non-selective period is reduced to minimize the power loss in the power supply unit due to the leak current.

Hereupon, the advantage of this embodiment in a case wherein the driving voltage is 4 Vpp, the selective voltage V_SEL is 12 V, the non-selective voltage V_REF is 6 V and the reset voltage V_INV is 2 V as the operating conditions of the embodiment will be described. In the absence of the resistor 49 under these operating conditions, the leak current per electron source was 1 μA and the power loss, 11 W. However, when the resistor 49 of 4.7 Ω in resistance was connected as shown in FIG. 6, the voltage drop of about 1.5 V is caused by this resistor 49. As a result, the leak current per electron source is reduced to 0.1 μA and the power loss, to 1.1 W. Thus, this embodiment provided the effect of improvement by about one digit.

Setting of the resistance of the resistor 49 will now be described. With the resistance of the resistor 49 being represented by R, the capacitance electron source by C and the number of electron sources in the line direction by N, it is preferable to so set the resistance R as to satisfy the condition of Mathematical Expression 1 below.
R·(C·N)≦0.2[μS] (Mathematical Expression 1)

If the resistance of the resistor 49 is too high, the time constant determined by the product CR of the resistance R of the resistor and the capacitance C of the electron sources is enlarged substantially, resulting in a drop in response speed. In a WXGA panel whose number of pixels is 1280×720, one horizontal period is about 20 μS. It is preferable for the delay in one horizontal period to be not more than 1/10of that. Therefore, as indicated by Mathematical Expression 1 above, it is preferable for the time constant on one line of electron sources due to the use of the resistor 49 to be not more than 0.2 μS, 1/10of 20 μS. This enables lo the drop in the responsiveness of electron sources due to the addition of the resistor 49 to be restrained.

Further, with the leak current caused by a potential difference between the driving voltage and the non-selective voltage V_REF to flow to one of the electron sources in the non-selective state being represented by Iₗₑₐₖ, the number of electron sources in the line direction by N, the number of electron sources in the row direction by M and the non-selective voltage by V_REF, it is preferable to so restrain the leak current Iₗₑₐₖ with the resistor 49 as to satisfy the condition of Mathematical Expression 2 below.
[Iₗₑₐₖ·N·(M−1)]·V_REF≦1[W] (Mathematical Expression 2)

In this embodiment, the upper limit of the permissible power loss in the non-selective state is set to 1 W. Since power consumption in the standby state is usually set to around 1 W in a lower power consumption television set, the power loss of 1 W in this embodiment in the non-selective state is considered low enough. Therefore, by so restraining with the resistor 49 the leak current flowing to electron sources in the non-selective state as to satisfy the condition of Mathematical Expression 2 above, the power loss in the non-selective period can be restrained sufficiently (to 1 W or less).

Further, with the resistance of the resistor 49 being represented by R, the resistance of the line wires by Rs, the voltage driving the row wires by E and the current to be restrained, namely the leak current by Iₗₑₐₖ, the relationship of Mathematical Expression 3 below holds.
R=E/Iₗₑₐₖ−Rs (Mathematical Expression 3)

Thus the resistance R of the resistor 49 may as well be determined with the wiring resistance of the line wires being taken into account. Then, it is preferable for the synthesized resistance of the resistor 49 and of the wiring resistance to satisfy the condition regarding the time constant represented by Mathematical Expression 1 above.

[Embodiment 2]

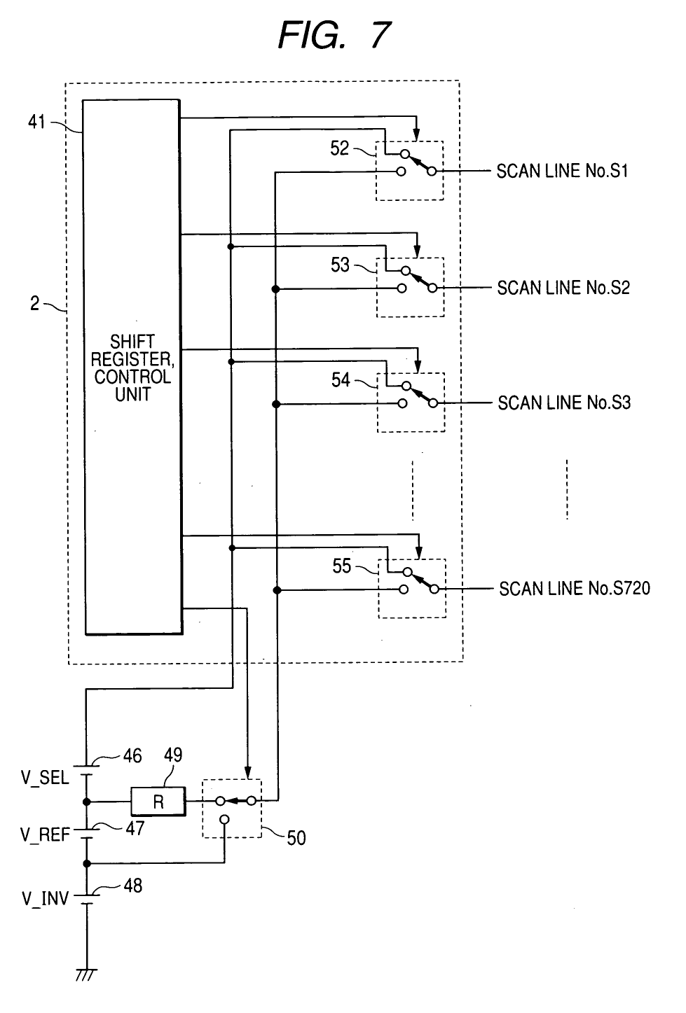

Next, a second preferred embodiment of the present invention will be described with reference to FIG. 7. FIG. 7 shows a second specific example of a scan driver 2 suitable for reducing power losses and its peripheries. In FIG. 7, elements having similar elements to their counterparts in FIG. 6 are assigned respectively the same reference numerals. A difference of this second embodiment from the first embodiment shown in FIG. 6 consists in that, while each of the switching elements 42 through 45 of a scan driver 2 in the first embodiment has three contacts, each of switching elements 52 through 55 in the second embodiment has only two contacts. Another difference from the first embodiment consists is the presence of an additional switching element 50 provided outside the scan driver 2 for selective switching-over between the non-selective voltage V_REF and the reset voltage V_INV.

The scan driver 2 in this embodiment has the control logic unit 41 which generates control pulses for line sequential scanning and the switching elements 52 through 55, each matching one or another of the line wires. The control logic unit 41 supplies control pulses not only to the switching elements 42 through 45 but also to the additional switching element 50.

Each of the switching elements 52 through 55, in response to a control pulse from the control logic unit 41, so operates as to select either one of the selective voltage V_SEL and the output signal of the additional switching element 50 and supply it to the matching line wire. The output terminal of the additional switching element 50 is connected to the switching elements 42 through 45. Further,a first input terminal of the switching element 50 is connected to the resistor 49 of a second voltage generator, and a second input terminal is connected to the third voltage source 48, which is a third voltage generator. The additional switching element 50, in response to a control pulse from the control logic unit 41, switches over to either the non-selective voltage V_REF from the second voltage source 47 or the reset voltage V_INV from the third voltage source 48, and outputs the selected one. The reset voltage V_INV is selected by the additional switching element 50 in the vertical blanking period of the image signal. Thus, the switching elements 52 through 55 selects the second input terminal, namely the first voltage source 46, in the selective period, and selects the output of second input terminal, namely the additional switching element 50, in the non-selective period and the vertical blanking period of the image signal. Although the first, second and third voltage sources are connected in series to each other in this embodiment as in the first embodiment, they may as well be connected in parallel.

When the line wire (scan line) No. S1 is to be selected for instance, the control logic unit 41 so controls the switching element 42 as to select the selective voltage V_SEL from the first voltage source 46, and so controls the switching elements 53 through 55 as to select the output signal from the additional switching element 50 in all other cases. Then the additional switching element 50, as the resistor 49 is selected in accordance with the control pulse from the control logic unit 41, the non-selective voltage V_REF is supplied to the line wires No. S2 through No. S720 via the resistor 49. Or when the line wire (scan line) No. S2 is to be selected, it so controls the switching element 43 as to select the selective voltage V_SEL from the first voltage source 46, and so controls the switching elements 52, 54 and 55 as to select the output signal from the additional switching element 50 in all other cases. The operation of the additional switching element is the same as in the above-described way.

In this embodiment, as described above, the operations of the switching elements 42 through 45 and the additional switching element 50 cause the resistor 49 to be connected to the line wires placed in the non-selective state and the electron sources connected thereto. The non-selective voltage V_REF is supplied to line wires in the non-selective state via this resistor 49. As in the first embodiment described earlier, since the flowing of a leak current to this resistor 49 invites a voltage drop, the MIM voltage varies downward (in the left direction of the characteristic 32 in FIG. 5). As a result, the leak current during the non-selective period is reduced to minimize the power loss in the power supply unit due to the leak current. The effect of improving the power loss when the resistance of the resistor 49 is set to 4.7Ω, for example, is the same as in the case of the first embodiment. In other words, the circuit configuration of this embodiment can provide the same effect as that of the first embodiment. Further, the resistor 49 can be set in the same as in the first embodiment described earlier.

In this way, in this embodiment of the present invention, leak currents in the non-selective period can be restrained to satisfactorily reduce the power loss in that non-selective period. This embodiment is especially effective where the leak currents from electron sources are raised beyond their usual level by various causes in the FED (electron sources) manufacturing process. Although the resistor 49 is used in this embodiment as the current restraining element to keep leak currents low, any other element than a resistor can be used for this purpose if only it has a function to restrain leak currents. It can be readily understood by persons skilled in the art that one of various elements or circuits having such a function can be applied. Further, though the non-selective voltage is supplied to every line wire via the resistor 49 in this embodiment, the configuration may as well be such that the non-selective voltage is supplied via the resistor 49 only to specific line wires whose leak currents are particularly large.

This embodiment also allows, even if leak currents between line wires and row wires result from fluctuations in manufacturing, the power loss accompanying scanning can be kept at or below a certain level. This enables the yield to be enhanced. It is also possible to set the non-selective voltage high to reduce the signal voltage to drive the row wires. Therefore, it is made possible to reduce power consumption by the data drivers, resulting in another advantage of making possible cost saving through large-scale integration of the data driving circuits.

The present invention can be applied to a display device having a mechanism in which leak currents occur where line wires and row wires cross each other. It can be particularly useful in reducing power consumption for scanning in an FED, organic EL or matrix placed LED display apparatus.

What is claimed is:

1. A display apparatus comprising:
a plurality of electron sources placed in a matrix form; and
scan drivers which apply a selective voltage to at least one line of electron sources out of the plurality of electron sources and a non-selective voltage to electron sources of other lines;
wherein the scan drivers apply the non-selective voltage to the other lines of electron sources via a current restraining element.

2. The display apparatus according to claim 1, wherein the current restraining element is a resistor.

3. The display apparatus according to claim 2, wherein leak currents flowing in electron sources to which the non-selective voltage is applied are reduced by the resistor.

4. A display apparatus comprising:
a plurality of electron sources placed in a matrix form;
data drivers which apply driver signals based on an input image signal to the electron sources arrayed in the line direction;
a first voltage source;
a second voltage source;
a current restraining element connected to the second voltage source; and
scan drivers including switching units which connect the first voltage source to at least one line of electron sources placed in a selective state out of the plurality of electron sources and the second voltage source to other lines of electron sources via the current restraining element.

5. The display apparatus according to claim 4, wherein the current restraining element is a resistor, the first voltage source generates the selective voltage to place the electron sources in the selective state, and the second voltage source generates the non-selective voltage to place the electron sources in a non-selective state and applies the non-selective voltage to the electron sources via the resistor.

6. The display apparatus according to claim 5, wherein, with the capacitance of the electron sources being represented by C, the resistance of the resistor by R and the number of electron sources in the line direction by N, the resistance R of the resistor is so set as to satisfy the following condition:
R·(C·N)≦0.2[μS]

7. The display apparatus according to claim 5, wherein, with the leak current which is caused by a potential difference between the driving voltage and the non-selective voltage to flow to one of the electron sources in the non-selective state being represented by Iₗₑₐₖ, the number of electron sources in the line direction by N, the number of electron sources in the row direction by M, and the level of the non-selective voltage by V_REF, the leak current Iₗₑₐₖ is so controlled with the resistor as to satisfy the following condition:
[Iₗₑₐₖ·N·(M−1)]·V_REF≦1[w]

8. A display apparatus comprising: p1 a display panel including M×N electron sources placed at the intersections of M line wires and N row wires, and phosphors which, placed opposite electron emitting elements, are excited by electrons emitted by the electron sources;
data drivers which apply driver signals based on an input image signal to the N row wires;
scan drivers which apply a selective voltage to at least one of the M line wires and a non-selective voltage to other line wires; and
a current restraining element which restrain currents flowing from the N row wires to the line wires to which the non-selective voltage has been applied.

9. The display apparatus according to claim 8, wherein the current restraining element is a resistor and the non-selective voltage is generated by a circuit including a voltage source connected to the resistor.

10. The display apparatus according to claim 9, wherein the scan drivers so operate as to apply a reset pulse to the electron sources during the blanking period of the image signal,
the non-selective voltage is so set as an intermediate potential between the selective voltage and the reset voltage that a forward bias voltage is applied to the electron sources during the period in which the selective voltage is applied and a backward bias voltage is applied to the electron sources during the period in which the reset voltage is applied.

11. The display apparatus according to claim 8, further comprising:
a first voltage source for generating the selective voltage;
a second voltage source, connected to the current restraining element, for generating the non-selective voltage; and
a third voltage source for generating a reset voltage;
wherein the scan drivers so operate as to select the selective voltage from the first voltage source in a selective period when electron sources connected to at least one line of row wires are driven, the non-selective voltage from the second voltage source in a non-selective period other than the selective period, and the reset voltage from the third voltage source in the blanking period of the image signal.

12. The display apparatus according to claim 8, further comprising:
a first voltage source for generating the selective voltage;
a second voltage source, connected to the current restraining element, for generating the non-selective voltage;
a third voltage source for generating a reset voltage; and
switching units for selecting either the non-selective voltage from the second voltage source or the reset voltage from the third voltage source;
wherein the scan drivers so operate as to select the selective voltage from the first voltage source in a selective period when electron sources connected to at least one line of row wires are driven, and the output of the switching units in a non-selective period or the blanking period of the image signal other than the selective period.

13. The display apparatus according to claim 8, wherein, with the resistance of the resistor being represented by R, the resistance of the line wires by Rs, the voltage to drive the row wires by E, and the restraining amperage by I, the resistance R of the resistor is so set as to satisfy the following condition:
R=E/I−Rs.

14. A display apparatus comprising:
a plurality of electron sources placed in a matrix form;
data drivers which apply driver signals based on an input image signal to the electron sources arrayed in the line direction;
a first voltage source for generating a first scan voltage;
a second voltage source for generating a second scan voltage; and
scan drivers which, when at least one line of electron sources out of the plurality of electron sources is to be operated, so select either the first scan voltage from the first voltage source or the second scan voltage from the second voltage source as to apply the first scan voltage to that one line of electron sources and the second scan voltage to other lines of electron sources;
wherein, with the leak current which is caused by a potential difference between the driving signal and the second scan voltage to flow to one of the electron sources in the non-selective state being represented by Iₗₑₐₖ, the number of electron sources in the line direction by N, the number of electron sources in the row direction by M, and the level of the second scan voltage by V_REF, the leak current Iₗₑₐₖ is so controlled as to satisfy the following condition:
[Iₗₑₐₖ·N·(M−1)]V_REF1[w]

15. The display apparatus according to claim 14, wherein the leak current Iₗₑₐₖ is controlled by a resistor connected to the second voltage source.
